(19) United States
(12) Patent Application Publication
(10) Pub. No.: US 2019/0315901 A1
(43) Pub. Date: Oct. 17, 2019

(54) UNSATURATED POLYESTER RESIN COMPOSITION

(71) Applicant: OSAKA SODA CO., LTD., Osaka-shi, Osaka (JP)

(72) Inventors: Suguru HASHIDATE, Osaka (JP); Ryosuke FUJIMOTO, Osaka (JP)

(21) Appl. No.: 16/470,883

(22) PCT Filed: Dec. 27, 2017
(86) PCT No.: PCT/JP2017/046897

§ 371 Date: Jun. 18, 2019

(30) Foreign Application Priority Data
Jan. 10, 2017 (JP) 2017-001524

(51) Int. Cl. C08F 283/01; C08F 236/20; C08F 236/22

(52) U.S. Cl. CPC C08F 283/01; C08F 236/22; C08F 236/20

(57) ABSTRACT

An object of the present invention is to provide very versatile unsaturated polyester resin compositions. According to the present invention it has been found that very versatile resin compositions can be obtained using unsaturated polyester resin compositions each containing an unsaturated polyester resin and an aliphatic multifunctional allyl ester represented by the following formula (1):

Z—(—COOCH₂—CH═CH₂)ₙ (1)
wherein n is an integer of 2 to 4; Z is an n-valent aliphatic hydrocarbon group, provided that Z is a bond only when n is 2.

### TECHNICAL FIELD

The present invention relates to unsaturated polyester resin compositions.

### BACKGROUND ART

Encapsulating resins have recently come into use for improving the reliability and productivity of electronic parts such as capacitors, coils, and resistors. Although the properties required for such encapsulating resins depend on the shape and size of the electronic parts, examples of physical properties include moisture resistance, low stress, high thermal conductivity, and impact resistance. Thermosetting resins such as diallyl phthalate resins and unsaturated polyester resins have been used as resins satisfying these properties.

For example, Patent Literature 1 describes that when a specific peroxycarbonate is used as a curing agent in an insulating resin composition containing an unsaturated polyester resin and a diallyl phthalate monomer, the resin composition can be cured at a relatively low temperature. However, only specific curing agents (initiators) can be used in such resin compositions. Therefore, it has been desirable to develop more versatile unsaturated polyester resin compositions.

### CITATION LIST

### Patent Literature

Patent Literature 1: JP 2010-209142 A

### SUMMARY OF INVENTION

### Technical Problem

An object of the present invention is to provide very versatile unsaturated polyester resin compositions.

### Solution to Problem

The present inventors have made extensive studies to find that very versatile resin compositions can be obtained using unsaturated polyester resin compositions each containing an unsaturated polyester resin and an aliphatic multifunctional allyl ester represented by the following formula (1):

Z—(—COOCH₂—CH═CH₂)ₙ (1)

wherein n is an integer of 2 to 4; and Z is an n-valent aliphatic hydrocarbon group, provided that Z is a bond only when n is 2. This finding has led to the completion of the present invention.

Specifically, the present invention can be described as follows.

Item 1. An unsaturated polyester resin composition, containing: an unsaturated polyester resin; and an aliphatic multifunctional allyl ester represented by the following formula (1):

Z—(—COOCH₂—CH═CH₂)ₙ (1)

wherein n is an integer of 2 to 4; and Z is an n-valent aliphatic hydrocarbon group, provided that Z is a bond only when n is 2.

Item 2. The unsaturated polyester resin composition according to Item 1, wherein the aliphatic multifunctional allyl ester of formula (1) is at least one selected from the group consisting of diallyl succinate, diallyl fumarate, diallyl maleate, diallyl itaconate, diallyl citraconate, and diallyl adipate.

Item 3. The composition according to Item 1 or 2, further containing an initiator.

Item 4. A cured product, obtained by thermally curing the unsaturated polyester resin composition according to any one of Items 1 to 3.

Item 5. A formed article, obtained by forming the unsaturated polyester resin composition according to any one of Items 1 to 3.

### Advantageous Effects of Invention

The present invention provides unsaturated polyester resin compositions which are very versatile while maintaining cure rate. In particular, an unsaturated polyester resin composition including an aliphatic multifunctional allyl ester containing an unsaturated bond in the molecular structure has a high peak temperature and its reaction is accelerated by the heat generated by that reaction. Therefore, the resin composition is excellent in production efficiency (e.g., heating conditions) during forming.

### DESCRIPTION OF EMBODIMENTS

Exemplary unsaturated polyester resin compositions are described in detail below.

### Unsaturated Polyester Resin Composition

The unsaturated polyester resin compositions of the present invention at least contain an unsaturated polyester resin and an aliphatic multifunctional allyl ester represented by the following formula (1):

Z—(—COOCH₂—CH═CH₂)ₙ (1)

wherein n is an integer of 2 to 4; and Z is an n-valent aliphatic hydrocarbon group, provided that Z is a bond only when n is 2.

### Unsaturated Polyester Resin

The unsaturated polyester resin used in the present invention may be any one known in the art. The unsaturated polyester resin, which is generally a compound produced by polycondensation (esterification) of a polyhydric alcohol with a polybasic acid (unsaturated or saturated polybasic acid), may be selected appropriately according to the desired properties.

The unsaturated polyester resin in the present invention may have a weight average molecular weight (Mw) of, for example, but not limited to, 3,000 to 50,000. The term “weight average molecular weight” as used herein means a value determined by gel permeation chromatography (Shodex GPC-101 available from Showa Denko K.K.) at room temperature with a standard polystyrene calibration curve.

The polyhydric alcohol used in the synthesis of the unsaturated polyester resin in the present invention may be any known one. Examples of the polyhydric alcohol include ethylene glycol, propylene glycol, neopentyl glycol, butanediol, diethylene glycol, dipropylene glycol, triethylene glycol, pentanediol, hexanediol, hydrogenated bisphenol A, bisphenol A, and glycerol. These polyhydric alcohols may be used alone or in combinations of two or more.

The unsaturated polybasic acid used in the synthesis of the unsaturated polyester resin in the present invention may be any known one. Examples of the unsaturated polybasic acid include maleic anhydride, fumaric acid, citraconic acid, and itaconic acid. These may be used alone or in combinations of two or more.

The saturated polybasic acid used in the synthesis of the unsaturated polyester resin may be any known one. Examples of the saturated polybasic acid include phthalic anhydride, isophthalic acid, terephthalic acid, HET acid, succinic acid, adipic acid, sebacic acid, tetrachlorophthalic anhydride, tetrabromophthalic anhydride, and endomethylenetetrahydrophthalic anhydride. These may be used alone or in combinations of two or more.

In view of properties such as heat resistance, mechanical strength, and formability, the polybasic acid is preferably an unsaturated polybasic acid. In order to more suitably achieve the effects of the invention, it is preferably a saturated polybasic acid, more preferably phthalic anhydride, isophthalic acid, terephthalic acid, tetrachlorophthalic anhydride, tetrabromophthalic anhydride, or endomethylenetetrahydrophthalic anhydride, still more preferably isophthalic acid or terephthalic acid, particularly preferably terephthalic acid.

The unsaturated polyester resin may be, but not limited to, a single unsaturated polyester resin or a combination of two or more unsaturated polyester resins. In order to more suitably achieve the effects of the invention, it is preferably a saturated polybasic acid-based unsaturated polyester resin in which a saturated polybasic acid is used as the polybasic acid in the synthesis of the unsaturated polyester resin, more preferably a terephthalic acid-based unsaturated polyester resin in which terephthalic acid is used as the polybasic acid in the synthesis of the unsaturated polyester resin.

The unsaturated polyester resin in the present invention can be synthesized by known methods using materials as mentioned above. The conditions for this synthesis need to be selected appropriately according to the materials used and the amounts thereof. Generally, esterification may be performed in a stream of inert gas such as nitrogen at a temperature of 140 to 230° C. under increased pressure or reduced pressure. In this esterification reaction, an esterification catalyst may be used, if necessary. Examples of the catalyst include known catalysts such as manganese acetate, dibutyltin oxide, tin(II) oxalate, zinc acetate, and cobalt acetate. These may be used alone or in combinations of two or more.

The unsaturated polyester resin in the present invention may be present in an amount within the range of 10 to 98% by weight, preferably 15 to 95% by weight, more preferably 20 to 90% by weight of the total amount of the unsaturated polyester resin composition. When the amount is within the above range, the effects of the invention can be sufficiently achieved.

### Aliphatic Multifunctional Allyl Ester (Cross-Linker)

The unsaturated polyester resin compositions of the present invention contain an aliphatic multifunctional allyl ester represented by the following formula (1):

Z—(—COOCH₂—CH═CH₂)ₙ (1)

wherein n is an integer of 2 to 4; and Z is an n-valent aliphatic hydrocarbon group, provided that Z is a bond only when n is 2.

In formula (1), n is preferably 2 or 3, particularly preferably 2.

In formula (1), the n-valent aliphatic hydrocarbon group preferably has 1 to 18 carbon atoms, more preferably 2 to 12 carbon atoms, still more preferably 2 to 6 carbon atoms, particularly preferably 2 to 4 carbon atoms, most preferably 2 or 3 carbon atoms.

The n-valent aliphatic hydrocarbon group may be a saturated n-valent aliphatic hydrocarbon group, or may partially have an unsaturated bond. In particular, in order to reduce the amount of cross-linker (multifunctional allyl ester) remaining unreacted to provide better physical properties to the resulting cured product, it preferably has one or more unsaturated bonds in the structure.

The n-valent aliphatic hydrocarbon group may have a branched structure, but is preferably a linear hydrocarbon group without a branched structure.

The n-valent aliphatic hydrocarbon group may contain a substituent such as a C1-C6 alkoxy group, a halogen atom, an allyl group, a vinyl group, or a hydroxy group, but preferably contains no substituent other than the n allyl ester groups.

Examples of such divalent aliphatic hydrocarbon groups include C1-C18 alkylene groups, alkenylene groups, and alkynylene groups. Preferred are alkenylene groups. Examples of the alkenylene groups include a vinylene group, a 1-propenylene group, a 2-propenylene group, a 1-butenylene group, a 2-butenylene group, a 1-pentenylene group, a 2-pentenylene group, a 1-hexenylene group, a 2-hexenylene group, and a 1-octenylene group. Preferred among these is a vinylene group.

When Z is a bond in formula (1), the aliphatic multifunctional allyl ester of formula (1) is diallyl oxalate.

Examples of the aliphatic multifunctional allyl ester of formula (1) include diallyl oxalate, diallyl malonate, diallyl succinate, diallyl glutarate, diallyl adipate, diallyl pimelate, diallyl suberate, diallyl azelate, diallyl sebacate, diallyl fumarate, diallyl maleate, triallyl citrate, diallyl tartrate, diallyl itaconate, and diallyl citraconate. These may be used alone or in combinations of two or more. Among these, diallyl succinate, diallyl fumarate, diallyl adipate, diallyl maleate, diallyl itaconate, and diallyl citraconate are preferred, with diallyl fumarate, diallyl maleate, diallyl itaconate, and diallyl citraconate being more preferred. Moreover, cis-type aliphatic multifunctional allyl esters are preferred, with diallyl citraconate or diallyl maleate being more preferred, with diallyl maleate being still more preferred, because they not only can enhance the peak temperature of the unsaturated polyester resin composition to accelerate its reaction by the heat generated by that reaction, thus providing excellent production efficiency (e.g., heating conditions) during forming, but also they allow the reaction to proceed sufficiently to produce a high-purity formed article with a small amount of non-cross-linked monomers.

The aliphatic multifunctional allyl ester of formula (1) in the present invention can be produced by reacting a carboxylic acid compound represented by the following formula (2) or an acid anhydride thereof with an allyl halide or an allyl alcohol, e.g., in the presence of an acidic substance, a basic substance, a catalyst, and a solvent. Carboxylic acid compounds of formula (2) are available as reagents or industrial chemicals.

Z—(COOH)n (2)

In the formula, n and Z are defined in the same manner as n and Z in formula (1).

Examples of the allyl halide include allyl chloride, allyl bromide, and allyl iodide. The allyl halide may be used in any amount. Usually, the amount is preferably within the range of 2 to 20 equivalents relative to the carboxylic acid compound of formula (2). In view of reaction rate and volumetric efficiency, the amount is more preferably within the range of 2.3 to 10 equivalents. Such allyl halide compounds are available as reagents or industrial chemicals.

Allyl alcohols are available as reagents or industrial chemicals. The allyl alcohol may be used in any amount. Usually, the amount is preferably within the range of 2 to 10 equivalents, more preferably 2 to 5 equivalents, relative to the carboxylic acid compound of formula (2).

Examples of the acidic substance include p-toluenesulfonic acid, dodecylbenzenesulfonic acid, and sulfuric acid. The acidic substance is preferably used in an amount within the range of 0.001 to 0.1 equivalents, more preferably 0.005 to 0.05 equivalents, relative to the carboxylic acid compound of formula (2).

Examples of generally used basic substances include hydroxides of alkali metals such as sodium hydroxide and potassium hydroxide; hydrides of alkali metals such as sodium hydride and potassium hydride; carbonates such as sodium carbonate and potassium carbonate; hydrogen carbonates such as sodium hydrogen carbonate and potassium hydrogen carbonate; and alcoholates. Also, organic bases may be used, such as quaternary ammonium compounds, aliphatic amines, and aromatic amines. The basic substance is preferably used in an amount within the range of 0.5 to 30 equivalents, more preferably 2 to 15 equivalents, relative to the carboxylic acid compound of formula (2).

Examples of catalysts that may be used include transition metals such as copper, iron, cobalt, nickel, chromium, and vanadium, and transition metal salts. Among these, copper compounds are suitable.

The copper compound used is not particularly limited, and almost all copper compounds may be used. Preferred examples include copper(I) chloride, copper(I) bromide, copper(I) oxide, copper(I) iodide, copper(I) cyanide, copper(I) sulfate, copper(II) sulfate, copper(II) chloride, copper(II) hydroxide, copper(II) bromide, copper(II) phosphate, copper(I) nitrate, copper(II) nitrate, copper carbonate, copper(I) acetate, and copper(II) acetate. Among these, copper(I) chloride, copper(II) chloride, copper(I) bromide, copper(II) bromide, copper(I) iodide, copper sulfate, and copper(II) acetate are particularly suitable because they are easily available and inexpensive.

The reaction may be performed in the presence or absence of a solvent. The solvent may be any one which has no adverse influence on the reaction. Examples include aromatic hydrocarbons such as benzene, toluene, and xylene; saturated aliphatic hydrocarbons such as hexane, heptane, octane, cyclohexane, and methylcyclohexane; ethers such as diethyl ether, diethylene glycol dimethyl ether, 1,4-dioxane, and tetrahydrofuran; esters such as ethyl acetate and butyl acetate; halogenated hydrocarbons such as methylene chloride, chloroform, and carbon tetrachloride; and dimethyl formamide, N-methylpyrrolidone, and sulfolane. One of these may be used alone, or two or more of these may be used in combination. The amount of the solvent, if used, may be any amount. Usually, the amount is preferably within the range of 0.01 to 20 times, more preferably 0.1 to 10 times the weight of the carboxylic acid compound of formula (2). In the reaction of interest, the aliphatic multifunctional allyl ester can be efficiently produced even without using any solvent.

Especially when a basic substance is used in the form of an aqueous solution in the reaction, a phase transfer catalyst is preferably used to promote the reaction. Examples of the phase transfer catalyst include, but are not limited to, quaternary ammonium salts such as trioctylmethylammonium chloride, tetrabutylammonium chloride, and tetrabutylammonium bromide; phosphonium salts such as tetrabutylphosphonium chloride; and crown ethers such as 15-crown-5 and 18-crown-6. The amount of the phase transfer catalyst, if used, is usually and preferably within the range of 0.001 to 1 equivalent, more preferably 0.01 to 0.4 equivalents, relative to the carboxylic acid compound of formula (2).

In order to provide a sufficient reaction rate while effectively reducing side reactions to achieve a high yield, the reaction temperature is usually and preferably within the range of −30° C. to 150° C., more preferably −10° C. to 120° C. The reaction duration is preferably within the range of 10 minutes to 15 hours. In order to reduce side reactions, the reaction duration is more preferably within the range of 10 minutes to 10 hours.

The reaction is preferably performed in an atmosphere of inert gas such as nitrogen or argon. The reaction may be performed under atmospheric pressure or under increased pressure, but in view of production equipment, it is preferably performed under atmospheric pressure. The reaction may be carried out, for example, by charging the materials at once or in portions into a stirring reactor and reacting them at a predetermined temperature for a predetermined duration as described in the paragraph [0034].

After completion of the reaction, the resulting reaction mixture may be neutralized, optionally followed by washing with, for example, water or saturated saline and then concentration, followed by a purification process commonly used in purification of organic compounds, such as distillation or column chromatography to obtain a high-purity aliphatic multifunctional allyl ester.

The unsaturated polyester resin compositions of the present invention preferably contain the aliphatic multifunctional allyl ester of formula (1) in an amount of 5 parts by weight or more, more preferably 10 parts by weight or more, still more preferably 15 parts by weight or more, particularly preferably 30 parts by weight or more, most preferably 50 parts by weight or more, but preferably 200 parts by weight or less, more preferably 150 parts by weight or less, particularly preferably 120 parts by weight or less, per 100 parts by weight of the unsaturated polyester resin.

### Initiator

The unsaturated polyester resin compositions of the present invention may include any polymerization initiator (thermal polymerization initiator or photopolymerization initiator).

The initiator (thermal polymerization initiator) is preferably, but not limited to, a peroxide compound or an azo compound. Specific examples include peroxide compounds, including diacyl peroxides such as benzoyl peroxide and lauroyl peroxide, dialkyl peroxides such as dicumyl peroxide and di-tert-butyl peroxide, peroxycarbonates such as diisopropyl peroxydicarbonate and bis(4-tert-butylcyclohexyl)peroxydicarbonate, and alkyl peresters such as tert-butyl peroxyoctoate and tert-butyl peroxybenzoate; and azo compounds, including 1,1′-azobis(cyclohexane-1-carbonitrile), 2,2′-azobis(2,4-dimethylvaleronitrile), 2,2′-azobis(4-methoxy-2,4-dimethylvaleronitrile), 2,2′-azobis(methylisobutyrate), α,α-azobis(isobutyronitrile), and 4,4′-azobis(4-cyanovaleric acid). Moreover, these initiators may be used alone or in combinations of two or more.

The unsaturated polyester resin compositions of the present invention preferably contain the initiator in an amount of 0.001 parts by weight or more, more preferably 0.005 parts by weight or more, still more preferably 0.01 parts by weight or more, particularly preferably 0.5 parts by weight or more, but preferably 10 parts by weight or less, more preferably 8 parts by weight or less, particularly preferably 5 parts by weight or less, per 100 parts by weight of the unsaturated polyester resin. Moreover, the initiator may be added directly to the unsaturated polyester resin composition, or may be dissolved in the aliphatic multifunctional allyl ester or another diluent (reactive monomer, e.g., diallyl phthalate) before addition.

### Inorganic Filler

An inorganic filler may be added, if necessary, to the unsaturated polyester resin compositions of the present invention. Examples of the inorganic filler include metal hydrates such as fused silica, crystalline silica, alumina, quartz glass, calcium carbonate, aluminum hydroxide, and calcium sulfate, glass powder, talc, and mica. These may be used alone or in combinations of two or more. The inorganic filler has a particle size of 0.1 to 100 μm, preferably 0.5 to 60 μm. Too small a particle size may cause the composition to have an increased viscosity which may prevent sufficient impregnation into a reinforcing fiber, thereby allowing incorporation of more air into the material and thus formation of more voids in the formed article. Also, too large a particle size will result in a decrease in the specific surface area of the particles, resulting in reduced fluidity.

The inorganic filler in the present invention may be added in an amount of 10 to 1000 parts by weight, more preferably 200 to 800 parts by weight, per 100 parts by weight of the unsaturated polyester resin. The addition of a smaller amount may cause reduced handleability of the material before forming. Also, the addition of a larger amount may cause a significant increase in viscosity, which may result in reduced fluidity during forming and in a reduced ability to impregnate a reinforcing fiber, thereby allowing incorporation of more air into the material and thus formation of more voids in the formed article.

In addition to the aforementioned components, the unsaturated polyester resin compositions of the present invention may contain components known in the art, such as a fibrous reinforcing agent, a low profile additive, a release agent, a thickening agent, a pigment, and/or a viscosity reducing agent, to an extent that does not impair the effects of the invention.

The fibrous reinforcing agent that may be used in the present invention may be any one known in the art. Examples of the fibrous reinforcing agent include a variety of organic and inorganic fibers such as glass fiber, pulp fiber, Tetoron® fiber, vinylon fiber, carbon fiber, aramid fiber, and wollastonite. These may be used alone or in combinations of two or more. In particular, it is preferred to use a chopped strand fiberglass cut to a fiber length of about 1.5 to 25 mm.

Examples of the low profile additive that may be used in the present invention include thermoplastic polymers commonly used as low profile additives such as polystyrene, polymethyl methacrylate, polyvinyl acetate, saturated polyesters, and styrene-butadiene rubbers. These may be used alone or in combinations of two or more.

Examples of the release agent that may be used in the present invention include stearic acid, zinc stearate, calcium stearate, aluminum stearate, magnesium stearate, and carnauba wax. These may be used alone or in combinations of two or more.

Examples of the thickening agent that may be used in the present invention include metal oxides such as magnesium oxide, magnesium hydroxide, calcium hydroxide, and calcium oxide, and isocyanate compounds. These may be used alone or in combinations of two or more.

The unsaturated polyester resin compositions of the present invention can be prepared by conventional methods in the art, such as kneading in a kneader or other devices. The cured products of the present invention can be produced by curing (thermally curing) the unsaturated polyester resin compositions of the present invention.

The unsaturated polyester resin compositions of the present invention can be formed (molded) into desired shapes and cured into formed (molded) products (formed (molded) articles). Forming and curing may each be performed by any conventional method in the art, such as compression molding, transfer molding, or injection molding.

The present invention is more specifically described hereinbelow with reference to examples. However, the present invention is not intended to be limited by these examples.

The materials used in the examples and comparative example described below are listed below.

### Unsaturated Polyester Resin

Unsaturated polyester resin: U-Pica 8552 available from Japan U-Pica Co., Ltd.

### Initiator

Bis(4-tert-butylcyclohexyl)peroxydicarbonate: Perkadox 16 available from Kayaku Akzo Corp.

tert-Butyl peroxybenzoate: Perbutyl Z available from NOF Corp.

### Cross-Linker

Diallyl phthalate: DAISO DAP monomer available from

Osaka Soda Co., Ltd.

Diallyl maleate: Synthesis Example 1

Diallyl fumarate: Synthesis Example 2

### SYNTHESIS EXAMPLE 1

### Synthesis of Diallyl Maleate

A 500-mL flask equipped with a Dean-Stark trap was charged with 145.2 g (2.50 mol) of allyl alcohol, 137.5 g (1.49 mol) of toluene, 98.1 g (1.00 mol) of maleic anhydride, and 6.53 g (0.02 mol) of dodecylbenzenesulfonic acid. The contents were stirred using a magnetic stir bar and heated and refluxed in an oil bath. The reaction was performed for eight hours while removing the water formed as the reaction proceeded using the Dean-Stark trap. Then, the heating was stopped and the flask was cooled down. The resulting reaction mixture was neutralized and washed with water, and then low-boiling-point components were evaporated using a rotary evaporator. The resulting concentrate was distilled under reduced pressure to obtain 176.6 g of target diallyl maleate. This compound was used in Example 1.

### SYNTHESIS EXAMPLE 2

### Synthesis of Diallyl Fumarate

A 500-mL flask equipped with a Dean-Stark trap was charged with 145.2 g (2.50 mol) of allyl alcohol, 137.5 g (1.49 mol) of toluene, 116.1 g (1.00 mol) of fumaric acid, and 6.53 g (0.02 mol) of dodecylbenzenesulfonic acid. The contents were stirred using a magnetic stir bar and heated and refluxed in an oil bath. The reaction was performed for 16 hours while removing the water formed as the reaction proceeded using the Dean-Stark trap. Then, the heating was stopped and the flask was cooled down. The resulting reaction mixture was neutralized and washed with water, and then low-boiling-point components were evaporated using a rotary evaporator. The resulting concentrate was distilled under reduced pressure to obtain 166.8 g of target diallyl fumarate. This compound was used in Example 2.

### Initiator Diluent

Diallyl phthalate: DAISO DAP monomer available from Osaka Soda Co., Ltd.

The following Table 1 shows the proportions of the components of the unsaturated polyester resin compositions used in the examples and comparative example. The proportions shown in the table are expressed in parts by weight, and the numbers in the parentheses are in parts by weight per 100 parts by weight of the corresponding unsaturated polyester resin.

### [Table 1]

### Unit: Parts by Weight

TABLE 1
Unit: parts by weight

| | Comparative | | | | | |
|---|---|---|---|---|---|---|
| | Example 1 | | Example 1 | | Example 2 | |
| Resin | | | | | | |
| Unsaturated polyester resin | 50.0 | (100) | 50.0 | (100) | 50.0 | (100) |
| Cross-linker | | | | | | |
| Diallyl phthalate | 50.0 | (100) | — | | — | |
| Diallyl maleate | — | | 50.0 | (100) | — | |
| Diallyl fumarate | — | | — | | 50.0 | (100) |
| Initiator | | | | | | |
| Bis(4-tert-butylcyclohexyl) | 0.50 | (1.0) | 0.50 | (1.0) | 0.50 | (1.0) |
| peroxydicarbonate | | | | | | |
| tert-Butyl peroxybenzoate | 0.25 | (0.5) | 0.25 | (0.5) | 0.25 | (0.5) |
| Initiator diluent | | | | | | |
| Diallyl phthalate | 0.50 | (1.0) | 0.50 | (1.0) | 0.50 | (1.0) |

### Preparation of Unsaturated Polyester Resin Composition

According to the proportions shown in Table 1, the unsaturated polyester resin and the cross-linker were weighed such that the sum of the weights of the resin and cross-linker was 50 g, and they were kneaded for five minutes in total using a planetary mill (Mazerustar KK250S available from Kurabo Industries Ltd.). Next, the mixture was stirred in the planetary mill while heated up to 80 to 90° C. until the unsaturated polyester resin was dissolved in the cross-linker. Once the unsaturated polyester resin was dissolved in the cross-linker to form a homogeneous solution, the heating and stirring were stopped and the solution was cooled down to room temperature. After the cooling to room temperature, the initiator diluted in the initiator diluent was added and the mixture was stirred in the planetary mill while being prevented from overheating to 30° C. or higher. Thereby, an unsaturated polyester resin composition was prepared.

### High-Temperature Curing Property Test

The unsaturated polyester resin composition was poured into a test tube having an outer diameter of 18 mm and a height of 165 mm (Model: P-18SM, available from Nichiden Rika-Glass Co., Ltd.) to a level of 7.62 cm from the bottom. A type K thermocouple was aligned with the middle (3.81 cm from the bottom) of the level of the poured resin. Then, in an oil bath heated to 65.5° C., the head of the test tube was adjusted such that the level of the poured resin was 1 cm below the liquid level of the oil bath. The gel time (the time period from 60.0° C. to 71.1° C.), cure time (the time period from 60.0° C. to the peak temperature), and peak temperature were recorded. The measurements are shown in Table 2.

TABLE 2

| | Comparative | | |
|---|---|---|---|
| | Example 1 | Example 1 | Example 2 |
| Gel time (min) | 9.2 | 12.2 | 9.1 |
| Cure time (min) | 16.1 | 23.3 | 17.9 |
| Peak temperature (° C.) | 122.9 | 216.8 | 109.4 |

Table 2 shows that Examples 1 and 2 using an aliphatic multifunctional allyl ester of formula (1) and Comparative Example 1 using diallyl phthalate exhibited comparably short gel times and cure times and thus excellent reactivity. Thus, it was found that the aliphatic multifunctional allyl esters of formula (1) can be used as alternatives to diallyl phthalate the use of which causes concern. Moreover, the peak temperature of Example 1 was high, which suggests that its curing reaction can be easily accelerated by the heat generated thereby. This in turn suggests that an increased amount of cross-linker can be involved in the reaction, and thus the residual unreacted cross-linker content can be reduced, resulting in a cured product having good physical properties.

Further, the compositions were sufficiently curable at temperatures as low as 60 to 70° C. in the high-temperature curing property test. This demonstrates that the aliphatic multifunctional allyl esters of formula (1) can be used as cross-linkers to provide very versatile unsaturated polyester resin compositions.

### INDUSTRIAL APPLICABILITY

The unsaturated polyester resin compositions of the present invention relate to unsaturated polyester resin forming materials which have very excellent fluidity without substantially impairing electrical and mechanical properties. The unsaturated polyester resin forming materials of the present invention can be used in applications including electric and electronic parts such as small, thin-walled coil bobbins, switch housings, terminal strips, connectors, and magnetic switches to take advantage of their excellent fluidity.

1. An unsaturated polyester resin composition, comprising:
an unsaturated polyester resin; and
an aliphatic multifunctional allyl ester represented by the following formula (1):
Z—(—COOCH₂—CH═CH₂)ₙ (1)
wherein n is an integer of 2 to 4; and Z is an n-valent aliphatic hydrocarbon group, provided that Z is a bond only when n is 2.

2. The unsaturated polyester resin composition according to claim 1,
wherein the aliphatic multifunctional allyl ester of formula (1) is at least one selected from the group consisting of diallyl succinate, diallyl fumarate, diallyl maleate, diallyl itaconate, diallyl citraconate, and diallyl adipate.

3. The unsaturated polyester resin composition according to claim 1, further comprising an initiator.

4. A cured product, obtained by thermally curing the unsaturated polyester resin composition according to claim 1.

5. A formed article, obtained by forming the unsaturated polyester resin composition according to claim 1.
